(19) United States
(12) Patent Application Publication
(10) Pub. No.: US 2011/0071668 A1
(43) Pub. Date: Mar. 24, 2011

(54) Vending machine monitoring system and its monitoring method

(75) Inventors: Ting-kuo Lin, Toayuan Hsien (TW); Chih-Hao Hsu, Taipei City (TW); Tien-Yuan Chien, Taipei City (TW); Chiu Wei, Taipei City (TW)

(73) Assignee: INTERNATIONAL CURRENCY TECHNOLOGY CORPORATION, Taipei (TW)

(21) Appl. No.: 12/585,640

(22) Filed: Sep. 21, 2009

(51) Int. Cl. G06F 17/00; G06F 3/00

(52) U.S. Cl. 700/232; 700/231; 710/15

(57) ABSTRACT

A vending machine monitoring method used in a vending machine monitoring system, which includes an automatic vending machine and a monitoring system that is attached to the automatic vending machine and uses a microprocessor to read in data signals transmitted between the main controller and peripheral apparatus (card-slide unit, bill acceptor, license recognition unit and coin slot unit) of the automatic vending machine through a connection interface, to process fetched data signals into waveform signals, to indicate any error message through an indicator light module, and to report processed waveform signals to an external remote system through a transmission module for display and further analysis and check of income.

### BACKGROUND OF THE INVENTION

1. Field of the Invention

The present invention relates generally to automatic vending machine monitoring technology and more particularly, to a vending machine monitoring system for monitoring the operation of an automatic vending machine, reading data signal transmitted between the main controller and peripheral apparatus of the automatic vending machine, and reporting the fetched data signal to a remove system for enabling a remote system user to obtain transaction data and any abnormal message on the real time. The invention relates also to the monitoring method used in the vending machine monitoring system.

2. Description of the Related Art

Following fast development of technology and human civilization, the pace of life has been getting faster. Hasty and busy atmospheres can be seen everywhere. In consequence, automatic vending machines are provided in public places and highly invited for the advantage of saving much labor and bringing convenience to people.

Subject to increase of vending items, advanced automatic vending machines must provide extra functions. However, different automatic vending machines from different providers provide different options and are operated in different manners, increasing the level of difficulty in management. An automatic vending machine business operator needs to send businessmen all installation sites to replenish commodities, collect money from the automatic vending machines and/or repair the automatic vending machines. After businessmen have recorded transaction-related data, the automatic vending machine business operator can know the actual quantity of commodities in stock, transaction records and machine failure status. This business operation manner has low efficiency, wastes much time, and increases the management and labor cost.

There are commercial automatic vending machines with counting function to count received coins and/or bills. However, error of automatic vending machine transaction data or shortage of income may occur due to human error or the factor of malicious modification or fraud. An automatic vending machine business operator may be unable to check every vending data with the income to find the fact. Further, following the coming of information era, people rely upon computer to control product research and development, product fabrication, product sale and inventory control management. An automatic vending machine business operator may introduce barcode recognition technology to prevent malicious modification and to simplify the operation flow and processing speed. However, the application of barcode recognition technology requires a person to pick up the internal data of every automatic vending machine at the installation site by means of using a barcode reader to scan the data and to store the data after through a barcode signal conversion. When the automatic vending machine business operator is going to check the storage content from the barcode reader, the barcode reader operator must transmit the storage content data to a remote computer at the site of the automatic vending machine business operator for decoding so that the automatic vending machine business operator can read the data. This method does not allow the automatic vending machine business operator to perform real-time control and management. When one automatic vending machine has a breakdown or a failure, the automatic vending machine business operator cannot know the situation on the real time, causing a delay in further commodity replenishment, money collection and failure repair. When this problem happened, it may result in a big loss. In consequence, the advantages of using automatic vending machines to expand sales channels cannot be fully realized. Increased time cost may limit the system function.

Accordingly, there is a strong need to provide a vending machine monitoring system that eliminates the aforesaid drawbacks and problems.

### SUMMARY OF THE INVENTION

The present invention has been accomplished under the circumstances in view. It is one object of the present invention to provide a vending machine monitoring system, which automatically monitors the operation of an automatic vending machine and gives a report to a remote system, simplifying management of automatic vending machine business and saving much the business operating cost.

To achieve this and other objects of the present invention, a vending machine monitoring system comprises an automatic vending machine and a monitoring system installed in the automatic vending machine for monitoring operation of the automatic vending machine. The monitoring system uses a microprocessor to read in signals of data communicated between the main controller and one of a set of peripheral apparatus of card-slide unit, bill acceptor, license recognition unit and coin slot unit of the automatic vending machine and signals of detection message including motor error/service inquiry message, peripheral apparatus error message, message of amount of money (bill) received by the bill acceptor, message of amount of money (coin) received by the coin slot unit, message of value of commodity purchased and commodity dispensing message, through a connection interface, to process fetched data signals into waveform signals, to indicate any error message through an indicator light module, and to report processed waveform signals to an external remote system through a transmission module for display and further analysis and check of income.

### BRIEF DESCRIPTION OF THE DRAWINGS

FIG. 1 is a system block diagram of a vending machine monitoring system in accordance with the present invention.

FIG. 2 is a flow chart of a vending machine monitoring method used in the vending machine monitoring system in accordance with the present invention.

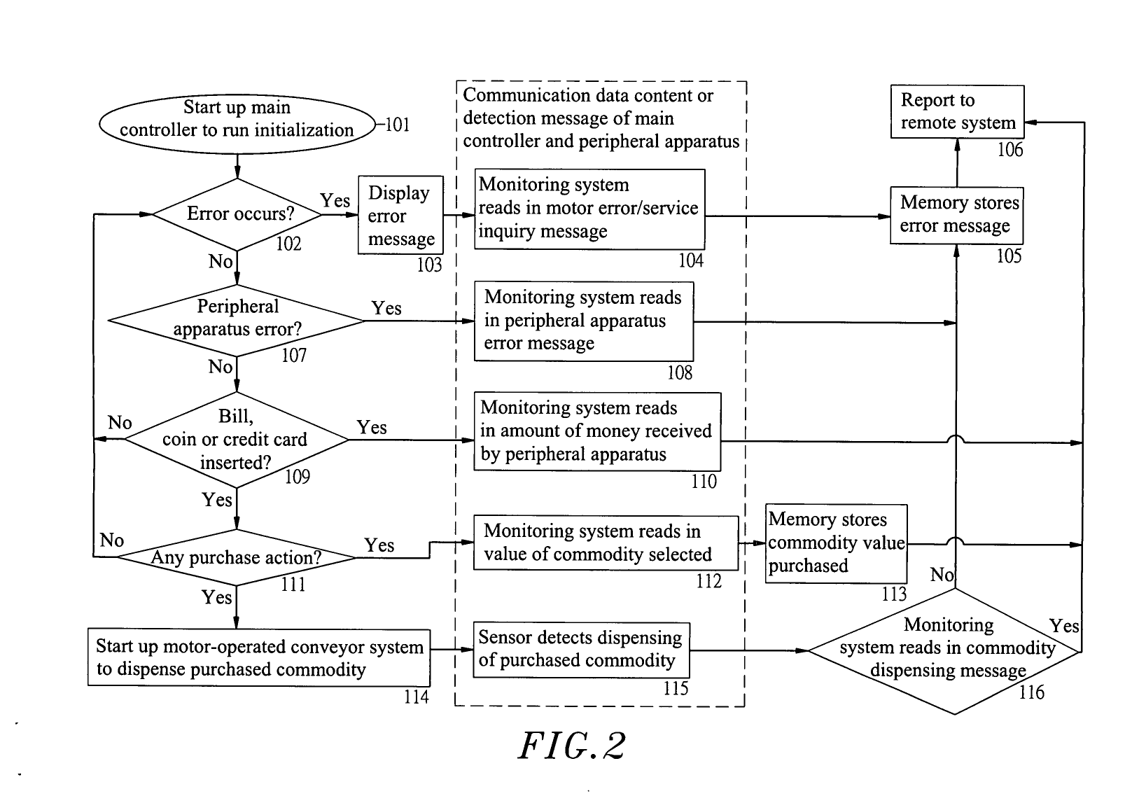

FIG. 3 is a schematic front view of the automatic vending machine of the vending machine monitoring system in accordance with the present invention.

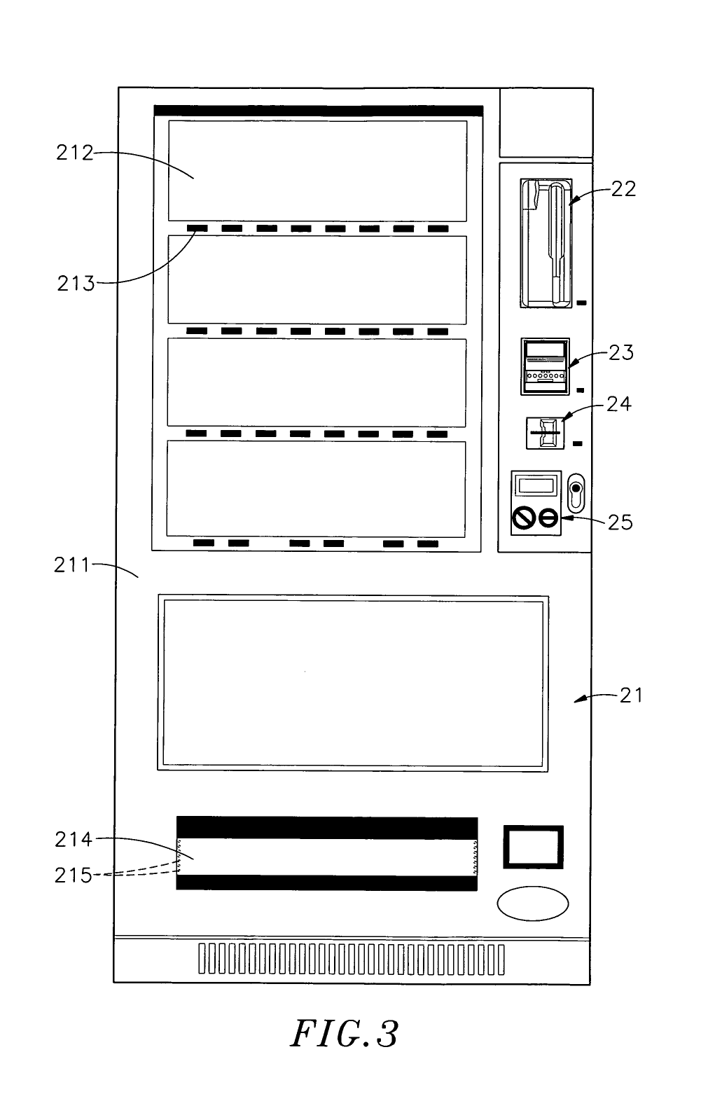

### DETAILED DESCRIPTION OF THE INVENTION

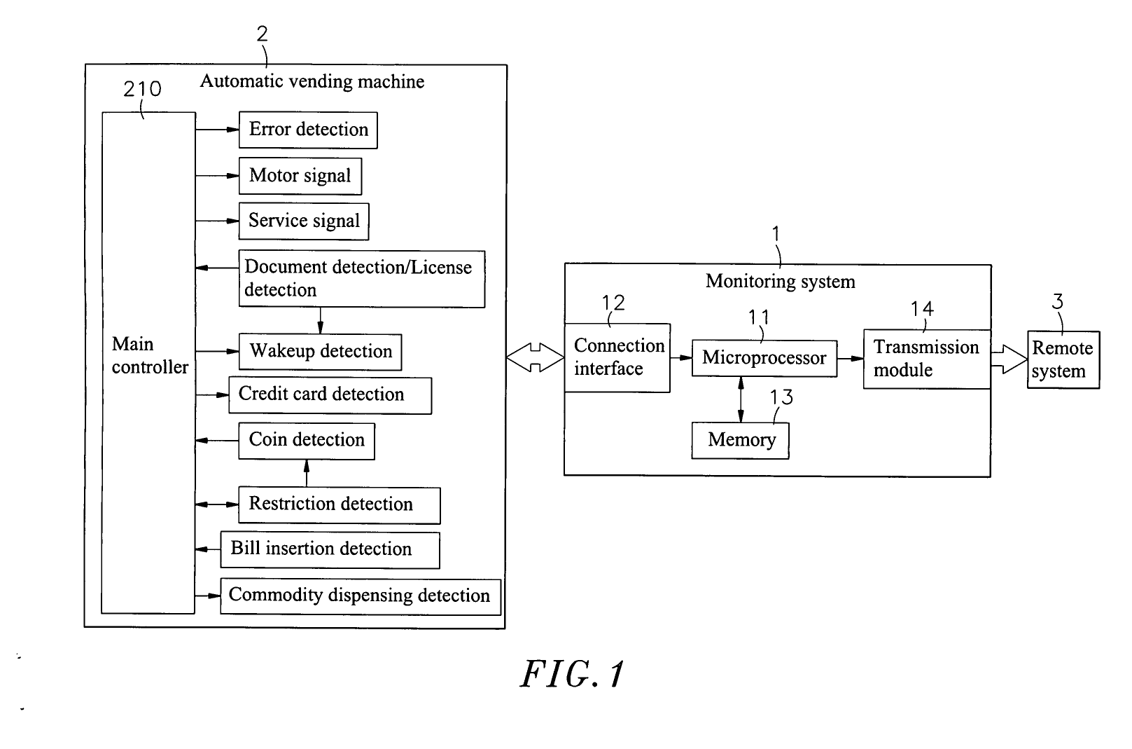

Referring to FIGS. 1˜3, a vending machine monitoring system in accordance with the present invention is shown comprising an automatic vending machine 2 and a monitoring system 1 attached to the automatic vending machine 2 for monitoring the operation of the automatic vending machine 2.

The monitoring system 1 comprises a microprocessor 11, a connection interface 12, a memory 13 and a transmission module 14. The microprocessor 11 is electrically connected to the automatic vending machine 2 through the connection interface 12 for reading in different data signals from the automatic vending machine 2, processing fetched data signals into waveform signals through a coding/decoding operation, and storing the waveform signals in the memory 13 and then reporting the storage waveform signals to a remote system 3 through the transmission module 14 or directly reporting the waveform signals to the remote system 3 through the transmission module 14 without storing them in the memory 13.

The automatic vending machine 2 comprises a housing 21, a card-slide unit 22, a bill acceptor 23, a license recognition unit 24 and a coin slot unit 25. The housing 21 has a front panel 211, a plurality of commodity exhibition zones 212 defined in the front panel 211, a plurality of buttons 213 respectively arranged on the front panel 211 at the bottom side of each of the commodity exhibition zones 212 corresponding to each item exhibited in each of the commodity exhibition zones 212, a commodity dispensing outlet 214 located on the front panel 211 near the bottom side. The card-slide unit 22, the bill acceptor 23, the license recognition unit 24 and the coin slot unit 25 are mounted in the housing 21 and exposed to the outside of the front panel 211. When a user wants to purchase a commodity from the automatic vending machine 2, the user must insert a personal license into the card-slide unit 22 or license recognition unit 24 for recognition. The user can insert coin(s) into the coin slot unit 25 or bill(s) into the bill acceptor 23 only after his (her) personal license has been passed the examination. After recognition of the inserted coin(s) or bill(s) by the coin slot unit 25 or bill acceptor 23 and press of one button 213 by the user, a main controller 210 in the housing 21 controls a motor-operated conveyor system (not shown) to deliver the selected age-restricted or identity-restricted commodity to the commodity dispensing outlet 214, at the same time a sensor 215 in the commodity dispensing outlet 214 detects the presence of the dispensed commodity, thereby completing the transaction and avoiding an unqualified person to purchase an age-restricted or identity-restricted commodity from the automatic vending machine 2.

The monitoring system 1 is mounted in the automatic vending machine 2 and electrically connected to the main controller 210 through the connection interface 12 so that the microprocessor 11 can read in any of a variety of data signals from the automatic vending machine 2. The data signal can be a signal of data content communicated between the main controller 210 and the peripheral apparatus of card-slide unit 22, bill acceptor 23, license recognition unit 24 or coin slot unit 25, or a signal of detection message, such as, motor error/service inquiry message, peripheral apparatus error message, message of amount of money (coin or bill) received by the bill acceptor 23 or coin slot unit 25, message of value of commodity purchased or commodity dispensing message. Further, the connection interface 12 can be CCTalk, RS232, MDB or Parallel interface, or an interface of any of other communication protocol interfaces. Further, the transmission module 14 can be connected to the remote system 3 by a wired connection technique or wireless connection technique for the transmission of a waveform signal. Further, the transmission module 14 can be a wired transmission module of public telephone network transmission interface, wired Internet transmission interface or DSL (Digital Subscriber Line) transmission interface, or a wireless transmission module of GSM (Global System for Mobile communications), GPRS (General Packet Radio Service), Bluetooth, Wireless LAN (Wireless Local Area Network) or radio transmission interface for transmitting a waveform signal processed by the microprocessor 11 to the remote system 3. Further, the monitoring system 1 can be designed having a compression unit (not shown) electrically connected to the microprocessor 11 for compressing a data signal received from the automatic vending machine 2 for enabling the compressed data signal to be further stored in the memory 13. After receiving of a waveform signal from the monitoring system 1, the remote system 3 decompresses and decodes the waveform signal for display on a display screen.

Further, the monitoring system 1 can be designed having an indicator light module (not shown) capable of producing different visual indication signals (such as emitting different colors of light or flashing at different frequencies) for normal/error indications subject to different operation status, and an AC or DC power supply unit (not shown) electrically connected to the microprocessor 11 to provide the necessary working voltage. When an AC power supply unit is used, a rectifier circuit is necessary to rectify AC into DC. Because the use of an indicator light module and an AC or DC power supply unit is of the known art and not within the scope of the spirit of the present invention, no further detailed description in this regard is necessary.

A vending machine monitoring method in accordance with the present invention runs subject to the following steps:
(101) Start up main controller 210 to run initialization.
(102) Automatically detect any error, and then proceed to step (103) when an error occurs, or to step (107) when normal.
(103) Display the error message.
(104) Monitoring system 1 reads in motor error/service inquiry message.
(105) Memory 13 stores the error message.
(106) Report to remote system 3.
(107) Detect peripheral apparatus functioning, and then proceed to step (108) when an error detected, or to step (109) when no any error detected.
(108) Monitoring system 1 reads in peripheral apparatus error message and then returns to step (105).
(109) Detect if there is any bill, coin or credit card inserted? And then return to step (102) when negative, or proceed to step (110) and step (111) simultaneous when positive.
(110) Monitoring system 1 reads in the amount of money received by the peripheral apparatus and then returns to step (106).
(111) Detect if there is any purchase action or not, and then return to step (102) when negative, or run step (112) and step (114) simultaneously when positive.
(112) Monitoring system 1 reads in the value of the commodity selected.
(113) Memory 13 stores the commodity value purchased, and then return to step (106).
(114) Start up the motor-operated conveyor system to dispense the purchased commodity.
(115) Sensor 215 detects dispensing of the purchased commodity.
(116) Monitoring system 1 reads in commodity dispensing message, and then proceed to step (105) when no commodity is dispensed, or to step (106) when the purchased commodity has been dispensed.

As stated above, the monitoring system 1 is attached to the inside of the automatic vending machine 2. When the automatic vending machine 2 is started up, the main controller 210 initializes firmware parameters and detects whether or not the machine is in an abnormal status. If the machine is in an abnormal status, the main controller 210 immediately controls the indicator light module to gives a visual error message. By means of the connection interface 12, the monitoring system 1 reads in data signals from the automatic vending machine 2. The data signal can be a signal of data content communicated between the main controller 210 and the peripheral apparatus of card-slide unit 22, bill acceptor 23, license recognition unit 24 or coin slot unit 25, or a signal of detection message, such as, motor error/service inquiry message, peripheral apparatus error message, message of amount of money (coin or bill) received by the bill acceptor 23 or coin slot unit 25, message of value of commodity purchased or commodity dispensing message. When fetched a data signal from the automatic vending machine 2 through the connection interface 12, the microprocessor 11 processes the fetched data signal into a waveform signal through a coding/decoding operation, and stores the waveform signals in the memory 13. After storage of the waveform signal in the memory 13, the microprocessor 11 reports the storage waveform signal to the remote system 3 through the transmission module 14. If the machine is not in an abnormal status, the main controller 210 detects the functioning of each peripheral apparatus. If any peripheral apparatus of the automatic vending machine 2 is in an abnormal status, the monitoring system 1 reads in the error message, and then stores the error message in the memory 13, and the reports the error message to the remote system 3. If all the peripheral apparatus of the automatic vending machine 2 are normal, the main controller 210 detects any insertion of a card, bill or coin into the peripheral apparatus of card-slide unit 22, bill acceptor 23, license recognition unit 24 or coin slot unit 25. When there is no any card, bill or coin inserted into one of the peripheral apparatus, repeat step (102). When there is a card, bill or coin inserted into the peripheral apparatus, the insertion of a credit card, bill(s) or coin(s) will be accepted only after insertion and recognition of a personal license (ID card, driver license or the like). After receipt of bill(s), coin(s) or deduction of a value from a credit card, the monitoring system 1 reports the data of the received amount of money to the remote system 3, and then the main controller 210 detects whether or not the user initiates a purchase action. When negative, the main controller 210 repeats step (102). When the user initiates a purchase action, i.e., when the user presses one or a number of the buttons 213 to select the commodity exhibited in the commodity exhibition zones 212, the monitoring system 1 fetches the data of the item, quantity and amount of the commodity purchased, and stores the data in the memory 13, and then reports the data to the remote system 3. At the same time, the main controller 210 drives the motor-operated conveyor system to dispense the selected age-restricted or identity-restricted commodity to the commodity dispensing outlet 214, and the sensor 215 detects the dispensing of the purchased commodity. If the purchased commodity is not accurately dispensed to the commodity dispensing outlet 214, the monitoring system 1 stores the error message in the memory 13. If the purchased commodity is accurately dispensed to the commodity dispensing outlet 214, the monitoring system 1 reports the message to the automatic vending machine 2, thereby completing the transaction.

The above description simply explains an application example of the present invention and should not be regarded as limitations of the present invention. The memory 13 used in the monitoring system 1 is for storing waveform signals processed by the microprocessor 11, avoiding erasure of communication data between the main controller 210 and the peripheral apparatus or reading disability in case of short circuit failure, machine failure, power failure or communication interruption. The waveform signal may be directly reported to the remote system 3 through the transmission module 14 without storing in the memory 13. Thus, the invention monitors the quality of commodity in stock, transaction record, transaction status and any failure of the automatic vending machine 2, and gives a visual warning signal in case an abnormality is found. Further, the automatic vending machine 2 can be made having the bill acceptor 23 and the coin slot unit 25 installed in the front panel 211 of the housing 21 without the card-slide unit 22 and the license recognition unit 24, or having the card-slide unit 22, the bill acceptor 23, the license recognition unit 24 and the coin slot unit 25 installed in the front panel 211, subject to the types of commodities to be sold, i.e., the automatic vending machine 2 can be designed for selling beverage, tobacco, ticket, memorial coin and/or gold.

The technical feature of the present invention is the use of the monitoring system 1 in an automatic vending machine 2. By means of the connection interface 12, the microprocessor 11 can read in communication data between the main controller 210 and peripheral apparatus (the card-slide unit 22, the bill acceptor 23, the license recognition unit 24 and the coin slot unit 25) in the housing 21 or any detection message, and process fetched data signal into a waveform signal, and then reports the waveform signal to a remote system 3 through the transmission module 14 wiredly or wirelessly so that the remote system 3 can process the waveform signal for display on a display screen. Thus, a remote system user can watch the transaction-related data displayed on the display screen, make an analysis, and check whether or not the income matches. By means of the application of the present invention, an automatic vending machine provider can monitor the quantity of commodity in stock, transaction records, transaction status, and functioning of all their automatic vending machines that are installed in different areas.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A vending machine monitoring system, comprising an automatic vending machine and a monitoring system installed in said automatic vending machine for monitoring operation of said automatic vending machine, wherein said monitoring system comprises:
a connection interface electrically connected to said automatic vending machine;
a microprocessor electrically connected with said connection interface and adapted for reading in data signals from said automatic vending machine, processing fetched data signals into waveform signals, and reporting the waveform signals to an external remote system; and
a transmission module electrically connected to said microprocessor for enabling said microprocessor to transmit the processed waveform signals to said external remote system for display the exceptional statue and the information of said automatic vending machine.

2. The vending machine monitoring system as claimed in claim 1, wherein said monitoring system further comprises a memory electrically connected to said microprocessor and controllable by said microprocessor to store said waveform signals.

3. The vending machine monitoring system as claimed in claim 1, wherein said connection interface is one of CCTalk, RS232, MDB and Parallel interfaces.

4. The vending machine monitoring system as claimed in claim 1, wherein said connection interface is electrically connected to a main controller of said automatic vending machine for enabling said microprocessor to read in signals of data communicated between said main controller and one of a set of peripheral apparatus of card-slide unit, bill acceptor, license recognition unit and coin slot unit of said automatic vending machine, and signals of detection message including motor error/service inquiry message, peripheral apparatus error message, message of amount of bills received by said bill acceptor, message of amount of coins received by said coin slot unit, message of value of commodity purchased and commodity dispensing message.

5. The vending machine monitoring system as claimed in claim 1, wherein said transmission module is a wired transmission module selected from the group of wired public telephone network transmission interface, wired Internet transmission interface and DSL (Digital Subscriber Line) transmission standards.

6. The vending machine monitoring system as claimed in claim 1, wherein said transmission module is a wireless transmission module prepared subject to one of GSM (Global System for Mobile communications), GPRS (General Packet Radio Service), Bluetooth, Wireless LAN (Wireless Local Area Network) and radio frequency transmission standards.

7. A vending machine monitoring method used in a vending machine monitoring system comprising an automatic vending machine and a monitoring system installed in said automatic vending machine and electrically connected with a microcontroller thereof to a main controller of said automatic vending machine (for reading in signals of data communicated between said main controller and one of a set of peripheral apparatus of card-slide unit, bill acceptor, license recognition unit and coin slot unit of said automatic vending machine and signals of detection message and processing fetched signals into waveform signals for storing in a memory of said vending machine monitoring system and reporting the waveform signals to an external remote system through a transmission module of said vending machine monitoring system the vending machine monitoring method comprising the steps of:
(A) Start up said main controller of said automatic vending machine to run initialization;
(B) Automatically detect any error, and then proceed to step (C) when an error occurs, or to step (G) when normal;
(C) Display the error message;
(D) Monitoring system reads in motor error/service inquiry message.
(E) Memory stores the error message;
(F) Report the error message to the remote system;
(G) Detect peripheral apparatus functioning, and then proceed to step (H) when an error detected, or to step (I) when no any error detected;
(H) Monitoring system reads in peripheral apparatus error message and then returns to step (E);
(I) Detect if there is any bill, coin or credit card inserted? And then return to step (B) when negative, or run to step (J) and step (K) when positive;
(J) Monitoring system reads in the amount of money received by the peripheral apparatus and then returns to step (F);
(K) Detect if there is any purchase action or not, and then return to step (B) when negative, or run step (L) and step (N) when positive;
(L) Monitoring system reads in the message of the value of the commodity selected;
(M) Memory stores the commodity value purchased, and then return to step (F); and
(N) Start up the motor-operated conveyor system to dispense the purchased commodity.

8. The vending machine monitoring method as claimed in claim 7, wherein the microprocessor of said monitoring system reads in signals of data communicated between said main controller and one of a set of peripheral apparatus of card-slide unit, bill acceptor, license recognition unit and coin slot unit of said automatic vending machine, and signals of detection message including motor error/service inquiry message, peripheral apparatus error message, message of amount of bills received by said bill acceptor, message of amount of coins received by said coin slot unit, message of value of commodity purchased and commodity dispensing message.

9. The vending machine monitoring method as claimed in claim 7, further comprising the steps of:
(O) Sensor detects dispensing of the purchased commodity to a commodity dispensing outlet of the automatic vending machine after the step (N); and
(P) Monitoring system reads in commodity dispensing message, and then proceed to step (E) when no commodity is dispensed to the commodity dispensing outlet, or to step (F) when the purchased commodity has been dispensed to the commodity dispensing outlet.
